(19) United States
(12) Patent Application Publication
(10) Pub. No.: US 2023/0385776 A1
(43) Pub. Date: Nov. 30, 2023

(54) EASING CROSS-GEO COLLABORATION WITH INTELLIGENT SCHEDULING

(71) Applicant: Microsoft Technology Licensing, LLC, Redmond, WA (US)

(72) Inventors: Gladys Tigounmo KENFACK, Bothell, WA (US); Mamta Debnath KUMAR, Redmond, WA (US); Tien Thuy DAO, Seattle, WA (US); Sara Cristina OROPEZA HERNANDEZ, Redmond, WA (US); Keyaria Deanna RHODES, Los Angeles, CA (US); Madrina THAPA, Athens, GA (US); Jaclynn Kristine HIRANAKA, Seattle, WA (US); Yaw Oduro AMOATENG, Oslo (NO); Dana Minh NGUYEN, Seattle, WA (US)

(21) Appl. No.: 17/804,424

(22) Filed: May 27, 2022

(51) Int. Cl. G06Q 10/10

(52) U.S. Cl. CPC G06Q 10/1095

(57) ABSTRACT

Methods and systems for scheduling virtual meetings across multiple geographic locations. In an example, the technology relates to a method for scheduling a virtual meeting. The method includes receiving configurations for location attributes and cross-geographic preferences for a plurality of users; storing the received configurations in a data storage; receiving, from a meeting organizer client device, a request for location attributes and cross-geographic preferences for one or more attendees of a virtual meeting; accessing, from the data storage, the requested location attributes and cross-geographic preferences for the one or more attendees; generating, based on at least the requested location attributes and cross-geographic preferences, a meeting time recommendation; and transmitting the accessed location attributes, cross-geographic preferences, and the generated meeting time recommendation to the meeting organizer client device.

### BACKGROUND

Conferencing software applications (often referred to as an “app” or “apps”) have become an essential tool for maintaining personal connections and for communicating or collaborating in a business environment. Virtual meetings, which take place through the internet using conferencing applications, are now common practice. It is also common that virtual meetings take place between individuals in different geographic locations, across widely disparate time zones. A conferencing application may provide an interface for a meeting organizer to schedule the meeting with attendees using a virtual calendar or scheduling feature associated with the conferencing app. In other examples, a separate application may provide the calendar or scheduling feature and interface with the conferencing application to arrange the virtual meeting.

It is with respect to this general technical environment that aspects of the present technology disclosed herein have been contemplated. Furthermore, although a general environment is discussed, it should be understood that the examples described herein should not be limited to the general environment identified herein.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Cross-geographic scheduling technology that improves scheduling of virtual meetings across disparate time zones while conserving and reducing computing costs associated with rescheduling and/or hosting multiple virtual meetings is disclosed. The technology allows for sharing location-based meeting preferences, as well as time zone and other location attributes, through unique systems that allow for live previews of attendees' calendars based on their respective time zones and even the times zones of those with whom they frequently collaborate. For example, in situations where individuals regularly collaborate with attendees in particular time zones, there may be a preference to set aside specific periods of the day for such collaborations, even if those periods are outside normal business hours. An attendee may choose to share these preferences with meeting organizers. Additionally or alternatively, an attendee may wish to automatically alert a meeting organizer that a proposed meeting time would occur outside of the attendee's normal business or waking hours in their respective time zones. With the new cross-geographic data signals available for scheduling, meetings are able to be more efficiently scheduled, which results in fewer meetings being canceled and fewer computing resources being wasted to hold such virtual meetings.

### BRIEF DESCRIPTION OF THE DRAWINGS

The following drawing figures, which form a part of this application, are illustrative of aspects of systems and methods described below and are not meant to limit the scope of the disclosure in any manner, which scope shall be based on the claims.

FIG. 1 depicts an example scheduling user interface.

FIG. 2 depicts another example scheduling user interface.

FIG. 3 depicts a user interface for setting cross-geographic settings.

FIG. 4 depicts a calendar preview user interface with time zones based on the cross-geographic settings.

FIG. 5 depicts an example meeting creating user interface.

FIG. 6 depicts an example system of computing devices in different time zones.

FIG. 7 depicts an example system for facilitating cross-geographic scheduling.

FIG. 8 depicts an example method for cross-geographic scheduling.

FIG. 9 depicts an example method for cross-geographic scheduling.

FIG. 10 is a block diagram illustrating example physical components of a computing device with which aspects of the technology may be practiced.

FIGS. 11A and 11B are simplified block diagrams of a mobile computing device with which aspects of the present technology may be practiced.

### DETAILED DESCRIPTION

Both business and personal communications increasingly rely on the use of conferencing applications to connect individuals and groups. These applications allow their users to conduct virtual meetings with one another via audio or video connections through the internet. Users of the conferencing application maintain a virtual calendar that allows them to indicate blocks of time that are available for virtual meetings or that are otherwise occupied. The virtual calendar may be inherent to the conferencing application or may be integrated into a separate application that interfaces with the conferencing application. Users typically make their virtual calendar visible to other individuals who are using a compatible virtual calendar (a process commonly referred to as “sharing”). For example, in a business environment, employees of a company maintain and share virtual calendars within the organization to facilitate meeting scheduling or to generally indicate availability of different users. In such an environment, a user may also choose to indicate additional times of the day or week that are not available for virtual meetings, such as weekends, holidays, vacations, or periods of the day that are outside of normal business hours.

To arrange the virtual meeting, a meeting organizer uses the shared virtual calendar within the conferencing (or an associated app) to select a meeting time that is commonly available for the attendees. One example of such a tool to facilitate scheduling is the Scheduling Assistant that is available in the OUTLOOK communications application from the Microsoft Corporation. The scheduling process, however, may become significantly challenged when attendees live and work in widely disparate geographic locations, where time zone differences complicate the selection of an agreeable meeting time. For example, a business meeting scheduled at 9 am Pacific Standard Time (at the beginning of the work day), would occur at 5 pm for attendees in the United Kingdom (at the end of their work day). Thus, there are very limited time intervals for meetings to be scheduled between these two locations during what would be considered normal business hours in both locations. Even larger time zone disparities may exist between attendees, where potential meeting times may extend beyond normal waking hours. These types of situations may arise in both business and personal circumstances and can be difficult for a meeting organizer to resolve. Indeed, recent studies have determined at least 4 hours a week are wasted just in scheduling and rescheduling meetings. This additional time is the result of technical limitations of the presently available technologies that do not provide, or have access to, sufficient signals or data to allow for efficient scheduling. Such limitations result in substantial network and computing resources being wasted by transmitting multiple messages and hosting meetings that may need to be rescheduled or duplicated.

The present disclosure introduces a set of related features that reduce the computing burden required to schedule meetings across geographic locations (herein referred to as “cross-geographic” collaboration) by improving scheduling technology. Unlike in-person meetings that are necessarily required to all be in the same time zone, virtual meetings have the ability to span many time zones throughout the world. As described below, these improved features allow users to share location-based meeting preferences, as well as time zone and other location attributes, through unique systems that allow for live previews of attendees' calendars based on their respective time zones and even the times zones of those with whom they frequently collaborate. For example, in situations where individuals regularly collaborate with attendees in particular time zones, there may be a preference to set aside specific periods of the day for such collaborations, even if those periods are outside normal business hours. An attendee may choose to share these preferences with meeting organizers. Additionally or alternatively, an attendee may wish to automatically alert a meeting organizer that a proposed meeting time would occur outside of the attendee's normal business or waking hours in their respective time zones. With the new cross-geographic data signals available for scheduling, meetings are able to be more efficiently scheduled, which results in fewer meetings being canceled and fewer computing resources being wasted to hold such virtual meetings.

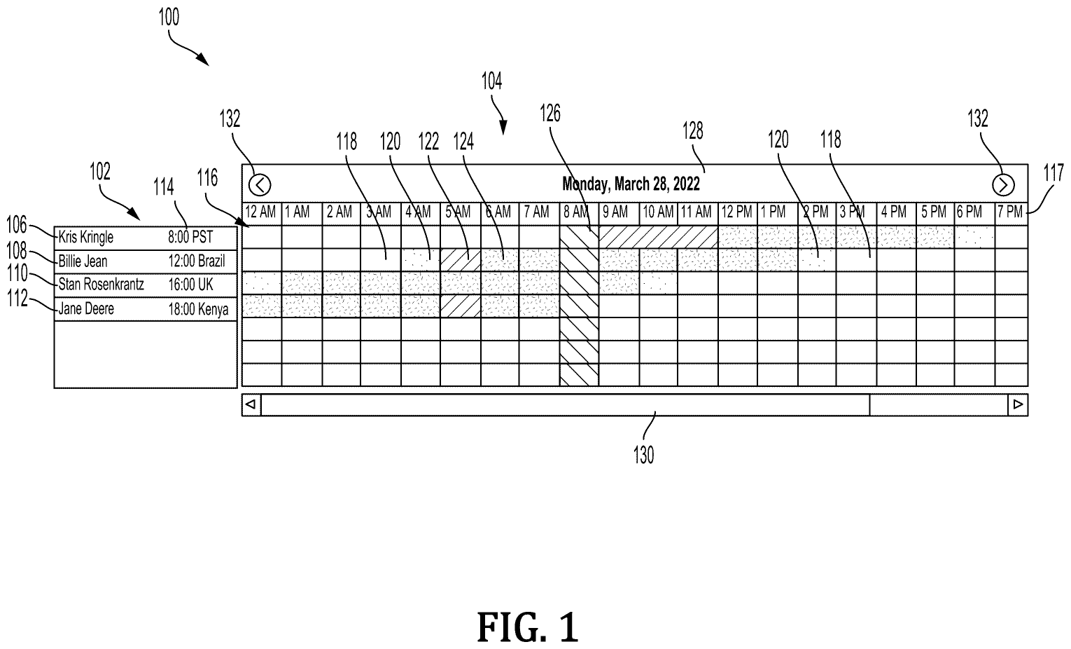

FIG. 1 depicts an example scheduling user interface 100. The scheduling interface 100 may be presented to a user that is attempting to schedule a virtual meeting. The user that is scheduling the virtual meeting may be referred to as the meeting organizer. The scheduling interface 100 includes an attendee pane 102 that includes multiple attendee indicators 106-112 that represent the different attendees that have been added to the meeting that is being scheduled. More specifically, the attendee pane includes a first attendee indicator 106, a second attendee indicator 108, a third attendee indicator 110, and a fourth attendee indicator 112. The first attendee indicator 106 may represent the meeting organizer (e.g., the user to whom the scheduling interface is being presented). While only four attendee indicators 106-112 are shown in the example depicted, greater or fewer attendee indicators may be included where a greater or fewer number of attendees have been added to the virtual meeting being scheduled.

The scheduling interface 100 may also include attendee time zone indicators 114. There may be an individual attendee time zone indicator 114 for each of the attendees, and the respective attendee time zone indicators 114 may be displayed adjacent the respective attendee indicator to indicate the time zone of the respective attendee. For instance, a first time zone indicator 114 is adjacent to the first attendee indicator 106 and indicates that the first attendee is in the Pacific Standard Time (PST) time zone. A second time zone indicator 114 is adjacent to the second attendee indicator 108 and indicates that the second attendee is in a Brazilian time zone. Additional time zone indicators 114 are also displayed for the third attendee indicator 110 and the fourth attendee indicator 112 to indicate the time zones of the third and fourth attendees, respectively. In the example depicted, the attendee time zone indicators 114 are displayed in the attendee pane 102, but in other examples the attendee time zone indicators 114 may be displayed in other portions of the example scheduling user interface 100 where the attendee time zone indicators 114 still connote the individual time zones for each attendee.

The time zone indicators 114 may also update to show local time for each attendee of the time selected for the meeting. In the example depicted, the current time selected for the meeting is 8 AM PST. Accordingly, because the example scheduling user interface 100 is being presented to the meeting organizer, which is represented by the first attendee indicator 106, the corresponding individual attendee time zone indicator 114 indicates 8 AM PST, which is the local time for the meeting organizer. The remaining attendee time zone indicators 114 are updated to the corresponding local time for the other attendees for the selected meeting time. For instance, the individual attendee time zone indicator 114 for the second attendee indicator 108 reflects 12 PM Brazil time, which would be the local time for the second attendee for the scheduled meeting time. Similarly, the individual attendee time zone indicator 114 for the third attendee indicator 110 is updated to indicate that the local time for the third attendee would 16:00 (e.g., 4 PM) in the United Kingdom. Accordingly, the meeting organizer is readily presented with information about what the local time would be for each attendee at the scheduled time of the meeting. From that presentation, the meeting organizer is able to readily discern whether the scheduled meeting time would be significantly inconvenient for one or more the attendees, such as if the meeting would be in the middle of the night for one or more of the attendees.

The example scheduling user interface 100 also includes a scheduling pane 104 with a calendar grid. The calendar grid includes a row 116 for each of the attendee indicators 106-112. Each row indicates availability for the respective attendee. Above the calendar grid is a date header 128 (e.g., Monday, Mar. 28, 2022), which indicates the selected date for the virtual meeting, and a time indication row 117. The time indication row 117 indicates a time slot for each column in the calendar grid. The times listed in the time indication row are in the time zone of the meeting organizer (e.g., the time zone of the first attendee indicator 106).

Portions of each of row 116 (e.g., each cell of the row) may be filled with different indicia (such as colors, cross-hatching, etc.) to indicate the status of the respective attendee's calendar at the corresponding time. For instance, in some scheduling systems, these indicia may include a “busy” or “free” indicator, where the busy indicator is a filled cell and a free indicator is an unfilled cell. The present technology may retain such indicia as well as new additional indicia based on the time zone(s) of the attendees. For example, some cells may be filled with a non-working or a non-waking indicator 118 that indicates the respective block of time is unavailable for the attendee because it is outside of the working or even waking hours of the attendee in his or her time zone. A working time indicator 124 may also be provided in cells to indicate the working hours for the attendee in the attendee's local time zone. A stretch time indicator 120 may also be provided in cells to indicate a stretch time for the attendee that is between the non-waking hours and the working hours for the attendee. Accordingly, in some examples, every time block/cell in each attendee row 116 is filled with a non-waking indicator 118, a stretch time indicator 120, or working time indicator 124. The time blocks/cells may also be filled with a scheduled or busy indicator 122 that indicates that a meeting has been scheduled for that attendee at the corresponding block of time.

As can be seen from the example depicted, the blocks of working time, non-waking time, and stretch time are shifted for each of the attendees based on their respective locations around the world. For example, the first attendee has stretch time from 8:30 AM to 9:00 AM PST and again from 6-6:30 PM PST. The third attendee has stretch time from 12:30 AM to 1:00 AM PST and from 10:00 AM to 10:30 AM PST. The fourth attendee has stretch time from 8:00 AM to 8:30 AM. The duration of the stretch time may be based on a default value such as 30 minutes or 60 minutes. In other examples, the duration of the stretch time may be based on an individual user setting or based on the location of the particular attendee. For instance, in the Pacific Time Zone, the morning stretch time may be longer, and in the Eastern Time Zone the evening stretch time may be longer.

The calendar grid may also include a selected time indicator 126, that indicate the time that has been selected for the meeting. In the example depicted, the time that has been selected is 8:00 AM to 8:30 AM PST. Based on the visual indicators displayed on the example scheduling user interface 100, the meeting organizer is able to see that the proposed time for the meeting is in stretch time for the first and fourth attendee and in working hours for the second and third attendees. Accordingly, while the proposed time for the meeting is not within working hours for all attendees, the proposed time is at least within waking hours for all the attendees, which makes the proposed time more reasonable for all attendees and more likely to be accepted. Without the indicia discussed herein, a meeting organizer would be unable to discern such global availability for the attendees without the use of significant additional computing resources, such as time zone websites and additional communications to determine the locations of each of the attendees.

The scheduling pane 104 includes additional navigation features to further assist a meeting organizer in selecting a meeting time. For example, the scheduling pane 104 includes a meeting date header 128, which indicates the day of the week for the proposed meeting, in addition to the date. In some examples, there may be no acceptable meeting time available on a particular day. The scheduling pane 104 may include a date scroll feature 132 that allows the meeting organizer to view potential meeting times on a different day. The date scroll feature 132 may be configurable to advance through days of the week or through larger epochs of time, such as full weeks. A horizontal scroll feature 130 may be necessary in order to visualize earlier or later periods of the day. For instance, the example depicted in FIG. 1 does not show attendee availability beyond 7:00 PM PST. The horizontal scroll feature 130 may be used to bring later times of the day into view from the right side of the scheduling pane 104 or earlier times of the day into view from the left side of the scheduling pane 104. A horizontal scroll feature 130 may not be necessary in examples where a larger view of the scheduling interface 100 is possible. For example, the meeting organizer's device may provide a display that is adequate for viewing the full 24-hour span of a day.

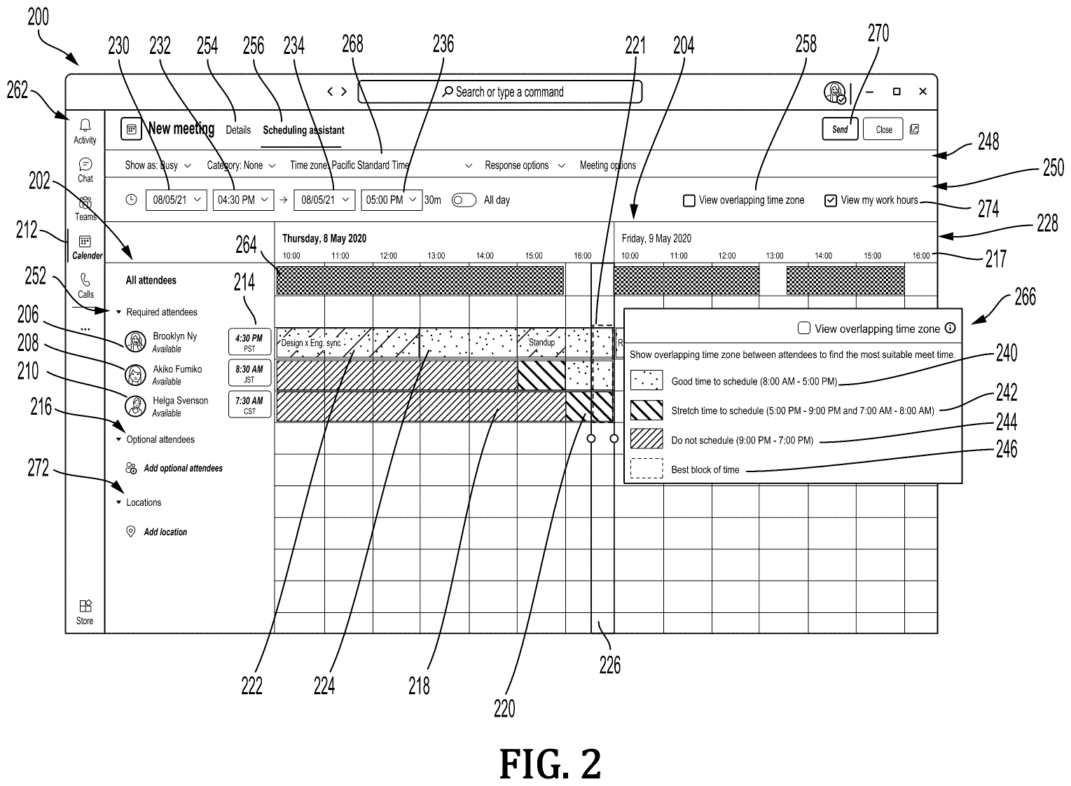

FIG. 2 depicts another example of a scheduling user interface 200. In this example, an attendee pane 202 and scheduling pane 204 are shown embedded within a virtual calendar feature 212 of another application. The scheduling interface 200 depicted in FIG. 2 is for a collaboration application, similar to the TEAMS collaboration or communication app from the Microsoft Corporation of Redmond, Washington. In other examples, the scheduling interface 200 may be incorporated into different types of applications, such as email applications, calendaring applications, or other types of applications that may be used for scheduling virtual meetings. The scheduling interface 200 may include a feature menu bar 262 that presents a plurality of functions of the application. The virtual calendar may be selected via a calendar option 212.

Similar to FIG. 1, the scheduling interface 200 of FIG. 2 includes an attendee pane 202 that includes multiple attendee indicators 206-210 that represent the different attendees that have been added to the meeting being scheduled. The first attendee indicator 206 may represent the meeting organizer (e.g., the user to whom the scheduling interface is being presented). While only three attendee indicators 206-210 are shown in the example depicted, greater or fewer attendee indicators may be included where a greater or fewer number of attendees have been added to the virtual meeting being scheduled. The scheduling interface 200 may also include attendee time zone indicators 214. There may be an individual attendee time zone indicator 214 for each of the attendees, and the respective attendee time zone indicators 214 may be displayed adjacent the respective attendee indicator 206-210 to indicate the time zone of the respective attendee.

The attendee pane 202 may allow for the display of attendees 206-210 to be controllable by way of a required attendee expansion menu 252 or similar feature which minimizes the view of attendees. The attendee pane 202 may include additional attendance features that can be configured by the meeting organizer. For instance, the meeting organizer may wish to include “optional attendees” whose attendance is not strictly required for the purpose of the meeting, but who may wish to be given the option of attending. The virtual calendar feature 212 may allow for the inclusion of optional attendees by way of an optional attendee expansion menu 216 or similar feature. Similar to the required attendee expansion menu 252, an optional attendee expansion menu 216 allows the meeting organizer to add these optional attendees, view attendee time zones 214, and view attendee availability and cross-geographic meeting preferences, as described in further detail below.

The attendee pane 202 may also include a feature for setting meeting locations. For example, a meeting location expansion menu 272, or similar feature, may be used to add or view physical meeting attendance locations. This type of feature may be integrated into the conference room reservation system of a business, where employees may reserve conference rooms located on the premises of the business. In examples where physical locations may represent reservable conference rooms, the meeting location expansion menu 272 may allow the meeting organizer to view time zone information and availability of these rooms on the calendar grid and reserve the rooms for attendees in their respective time zones. For example, a meeting organizer located in the Pacific Time Zone in the US, may reserve a conference room in the UK for coworkers attending the meeting from that location. In other examples, the meeting organizer may not be required to reserve or specify physical locations, or the meeting may be solely virtual meeting.

Similar to FIG. 1, the scheduling pane 204 depicted in FIG. 2 includes a meeting date header 228, which indicates the day of the week for the proposed meeting, in addition to the date. The scheduling pane 204 includes a time indication row 217, which indicates a status of a corresponding time slot for each column in the calendar grid. The scheduling pane may also include a conflict indication row or indicator 264, which aggregates and displays meeting attendee conflicts from the rows of the calendar grid and may help the meeting organizer quickly identify commonly available meeting times. In the example depicted in FIG. 2, the attendees have openings in the 4 PM-5 PM PST time slot (16:00-17:00), as indicated by the opening in the hashed region.

The calendar grid displays additional contextual details to assist the meeting organizer in identifying acceptable cross-geographic meeting times. Meeting availability indicia are provided in the form of a busy indicator 222, a working time indicator 224, a non-waking indicator 218, and a stretch time indicator 220. In other examples, the availability indicia may include different types of availability status, or may include a greater or fewer indicators of meeting availability. A selected time indicator 226 highlights the time that has been selected for the meeting. The times displayed in the attendee time zones 214 may be updated to indicate the local time for each attendee, in his or her time zone, corresponding to the selected time indicator 226.

The scheduling interface 200 may also include a meeting time preferences legend 266, which helps the meeting organizer interpret the availability indicia. The meeting time preferences legend 266 may be selectively displayed and removed from display. In the present example, the meeting time preferences legend 266 includes a working time label 240, a stretch time label 242, and a non-waking label 244. These labels correspond to the indicators displayed on the calendar grid. While the meeting time preferences legend 266 depicted in this example includes specific time periods associated with each label (e.g., 8:00 AM-5:00 PM for the working time label 240), in other examples, the labels may not include a specific time period that is applicable to all users. As described below, the technology may include a feature that allows each user to define a preferred period of time to associate with each availability indicator. For instance, each user may define his or her stretch time or do not schedule time (e.g., no working hours). Thus, the meeting time preferences legend 266 may not display a single time period associated with each label.

The scheduling pane 204 may also include a meeting time recommendation indicator 221 that indicates a best block of time to schedule the meeting based on the various time zones and calendars of the attendees in the attendee list. The meeting time recommendation indicator 221 may be a border or fill of the block(s) of time in the calendar grid that indicates the determined best block of time. The best block of time determination may be based on a set of logic, heuristics, and/or machine learning models that may be executed locally be the device operating the communication application or in a cloud-based environment. Details of such decision logic are described in further detail below. In examples where such a feature is enabled, a meeting time recommendation label 246 may be displayed in the meeting time preferences legend 266.

The scheduling interface 200 also includes features that are generally associated with the configuration or display of time zone related preferences or signals. Within the meeting date/time selection ribbon 250 is a view overlapping time zone selector 258, which allows the organizer to toggle the display of attendee time zone information on or off. There may also be a view local working hours selector 274, which allows the meeting organizer to view the his or her own working hours preferences in conjunction with the location-based preference of the attendees. The meeting date/time selection ribbon 250 may include meeting scheduling features such as meeting start date 230, meeting start time 232, meeting end date 234, and meeting end time 236. These features are displayed to the meeting organizer in the meeting organizer's local time, with associated cross-geographic times being displayed to the meeting organizer via the attendee time zones 214, as described above.

The scheduling interface 200 may also provide additional meeting configuration options, through a meeting options ribbon 248. One such option that is particularly relevant to the present technology is a time zone selector 268, which allows the meeting organizer to set his or her local time zone. The scheduling interface 200 may provide still further meeting configuration options, accessible through a meeting details selector 254, in addition the those described above, which may be associated with a scheduling assistant selector 256. Once the meeting is configured to the preferences of the meeting organizer, a send button 270 may be selected to transmit or disseminate the meeting invitation.

The scheduling interface 200 depicted in FIG. 2 is intended to illustrate one example of how cross-geographic meeting information and preferences are displayed to a meeting organizer. The example depicted in FIG. 2, however, is merely one example of such functionality, and other examples are also contemplated.

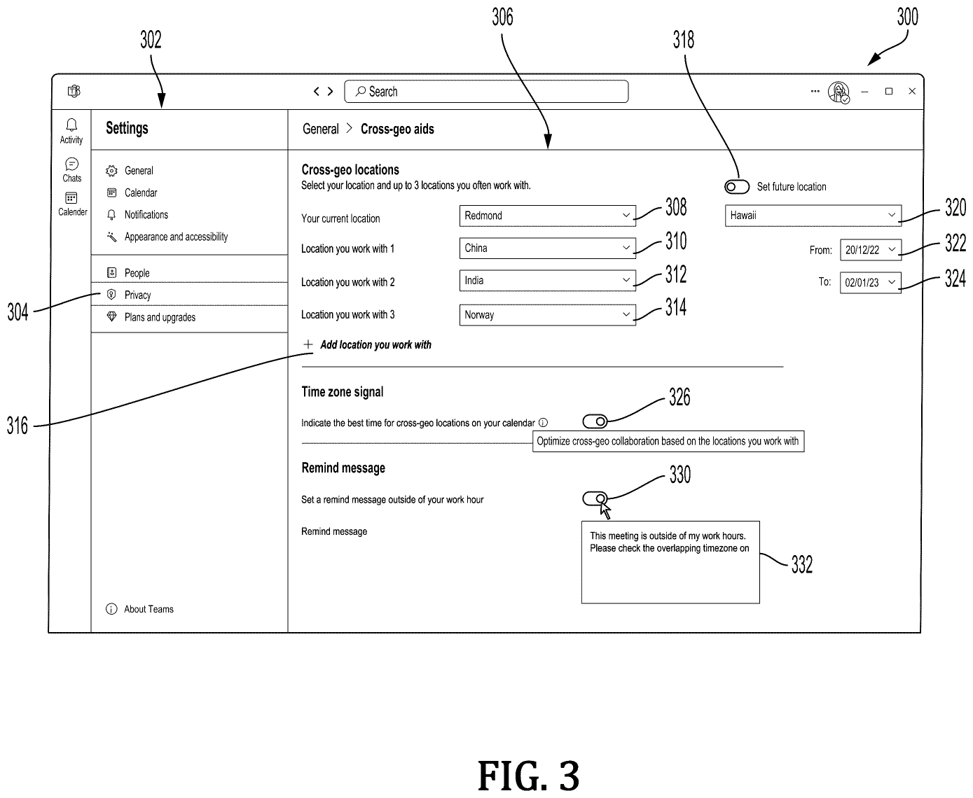

FIG. 3 depicts a cross-geographic user interface 300 for setting cross-geographic preferences. The cross-geographic user interface 300 is displayed to a particular user and allows for location attributes and cross-geographic preferences for that user to be set. One or more geography-based signals or data structures regarding the users cross-geographic preferences may then be generated and used for scheduling or calendaring.

The cross-geographic user interface 300 may be integrated within a conferencing applications or other types of communication or scheduling applications, as discussed herein. The cross-geographic user interface 300 includes a settings pane 302, which may contain a data privacy settings tab 304, or functionally similar feature, for setting shared-data preferences. A cross-geographic preferences pane 306, which is associated with the data privacy settings tab 304, may contain a plurality of location-based user preferences that may be configured for later sharing and communication to other users that may be scheduling a meeting. For example, the cross-geographic preferences pane 306 may include a current location selector 308, from which the user's current location may be selected from a pre-defined list of locations. Additionally or alternatively, the current location selector 308 may include a text-based input for the user to enter his or her current location via physical or virtual keyboard. The current location selector 308 is used to generate a time zone signal for the user. That time zone signal may be shared with other users and visualized, for example, as an attendee time zone 214 in a meeting organizer's attendee pane 202.

The cross-geographic preferences pane 306 may provide options for setting future locations. For instance, if the user knows that he or she will be in a different location for a period of time in the future, the user may set that different location for the corresponding time period. The time zone signal that is generated for the user may then be altered over the set time period. Once the time period has concluded, the time zone signal for the user defaults back to the current location set in current location selector 308. In the example, depicted a future location toggle option 318 is displayed in the cross-geographic preferences pane 306. When the future location toggle option 318 is selected, a future location input element 320, a future location start date input element 322, and a future location end date input element 324 may be displayed to allow a user to configure his or her future location. The time zone signal may be considered a location attribute for the user.

The cross-geographic preferences pane 306 may include a plurality of cross-geographic locations, such as a first cross-geographic team location input element 310, a second cross-geographic team location input element 312, and a third cross-geographic location input element 314. These cross-geographic team locations 310-314 correspond to specific time zones where people with whom the user frequently works reside. For instance, the user may frequently interact with, and attend virtual meetings with, teams that are located across the globe. As should be appreciated, some times of the day for a user work better for scheduling meetings with people in certain time zones. For instance, for a user in the Pacific Time zone, time later in the day or early evening may be better for scheduling meetings with people in China, whereas time earlier in the day may be better for scheduling meetings with people in New York. The present technology utilizes the inputs into the cross-geographic team location elements to generate additional cross-geographic signals that help generate recommended scheduling times that accounts for blocks of time that may be best used for different attendees across the globe. For instance, the conferencing application, virtual calendar, or related scheduling feature may use these location-based time zone preferences to automatically reserve, or weight, portions of that attendee's daily schedule for virtual meetings with these cross-geographic locations 310-314.

In the example depicted, the user has indicated that the user frequently works with people from China, India, and Norway, which all are in quite different time zones. Continuing with the depicted example, a prospective attendee located in the Pacific time zone (PST) in the United States (e.g., Redmond, WA) may frequently collaborate with colleagues located in Norway (PST +9 hrs.). The present technology may use the third cross-geographic location 314 to automatically reserve, or weight, the 8 AM to 10 AM time period in the attendee's virtual calendar for meetings with colleagues located in Norway. This time period may appear as “busy,” “tentative,” or as “stretch time,” or as a prioritized time slot to meeting organizers located outside of Norway, who are attempting to schedule a potentially competing meeting with the attendee. In other examples, a different indicator (other than busy, tentative, free, or stretch time) may be indicated on the user's calendar or respective row of a calendar grid view that indicates the 8-10 AM time slot is preferred for meetings with those in Norway (or in the same time zone as Norway). For meeting organizers located in Norway, however, this time period may appear as “available” or as “stretch time” for the attendee. Accordingly, based on the location or time zone of the meeting organizer, the indicators for the row of the user in the calendar grid may appear differently. Similar to the current location selector 308, the cross-geographic locations 310-314 may be implemented as pre-defined lists of locations, or the locations may be text-based inputs from the user. The cross-geographic preferences pane 306 may also provide an additional location entry option 316, with which a user may specify additional cross-geographic locations for reserving meetings times.

A selectable option 326 may also be provided to allow for the user to select whether the user desires to share his or her cross-geographic signals or preferences and/or the location attributes. When toggled “on”, the cross-geographic signals generated from the cross-geographic preferences provided by the user are shared with others that attempt to schedule a meeting with the user. Such a feature allows for additional privacy controls for the user. Additionally or alternatively, further levels of details may also be selectable or configurable to allow the user to set how many details of the preferences are shared and to which persons those details are shared. For instance, the user may be able to indicate that such signals should only be shared with certain users or persons within the user's organization.

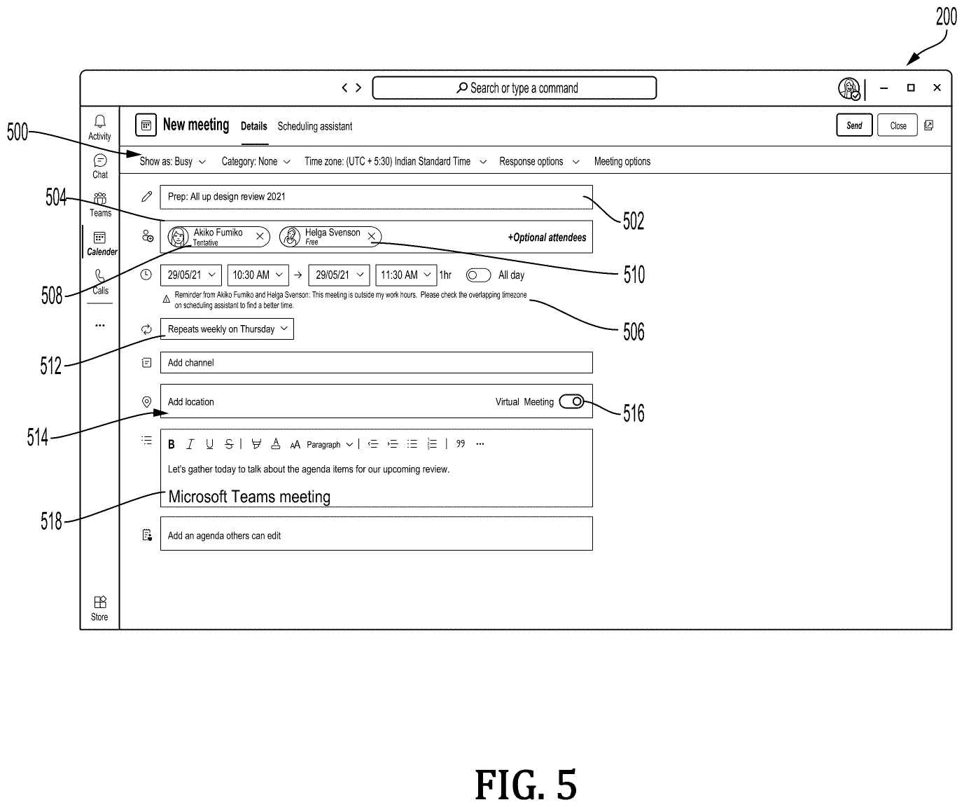

The cross-geographic preferences pane 306 may also include a geographic reminder section, including send-message option 330. When the send-message option 330 is selected or toggled “on,” a reminder message is displayed to meeting organizers that attempt to schedule a meeting with the user outside of working or waking hours of the user in the user's time zone. A message customization input element 332 may be provided to allow the user to customize the message that is provided. An example display of such a message is shown in FIG. 5 and discussed below with respect to FIG. 5.

In addition to virtual meeting scheduling, the configured reminder message may be sent when a communication message is being drafted to the corresponding user outside of that user's working hours. For example, if the “To” line of an e-mail is populated with a contact or user, a query of that user's location attributes may be performed. If the message would be sent after work hours of that user in the user's local time, the reminder message may be displayed within the e-mail drafting interface. Similarly, chat-based messaging in collaboration applications, such as the TEAMS application, may similarly trigger such reminder messages. For instance, if a chat-based message is being drafted to another user, the reminder message may be displayed if the message would be received after working hours in the recipient's local time.

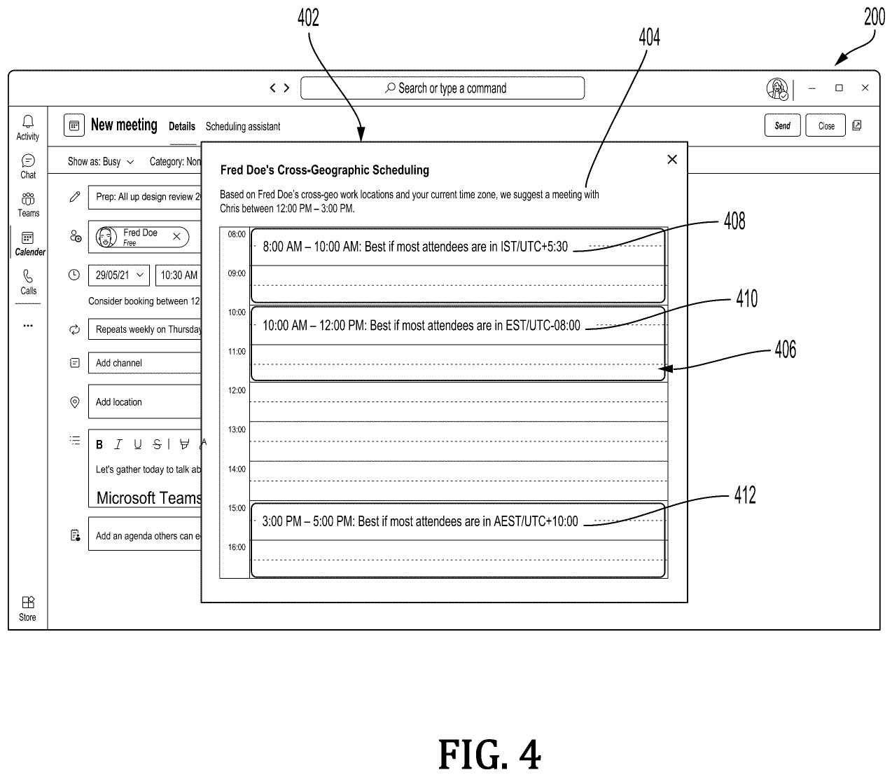

FIG. 4 depicts a calendar preview user interface 402 with time zones based on the cross-geographic settings. The calendar preview user interface 402 is presented to a user who is in the role of a meeting organizer attempting to schedule a meeting with another user named Fred Doe. The meeting organizer has added Fred Doe as an attendee to the meeting. Fred Doe has previously configured his cross-geographic team location preferences to indicate that he frequently works with teams in the following time zones (1) IST/UTC+5:30, (2) EST/UTC-08:00, and (3) AEST/UTC+10:00. Based on Fred's cross-geographic team location preferences, the present technology determines the most likely blocks of time for which Fred should (or would most likely) schedule meetings with team members from those three time zones. Such determinations or decisions may be made based on heuristics or machine-learning models. In any case, the decision logic or models may be updated based on monitored interactions and calendaring activities, as discussed further herein. The priority blocks of times may also be manually adjusted or configured by the user in some examples.

The calendar preview user interface 402 may be selectively activated through a selection of a corresponding user interface element in a meeting scheduling user interface. When activated, the calendar preview user interface 402 displays a calendar view 406 showing hours for a selected day of the potential meeting. The calendar view 406 is presented in the time zone of the meeting organizer (e.g., the user viewing the calendar preview user interface 402). Blocks of time are indicated based on Fred Doe's current time zone (or scheduled time zone for the day of the potential meeting) and Fred Doe's cross-geographic preferences. In the example depicted, a first geographic priority indicator 408 over a first block of time, a second geographic priority indicator 410 over a second block of time, and a third geographic priority indicator 412 over a third block of time are displayed. Each of the geographic priority indicators 408-412 indicate different blocks of time that should be prioritized for meetings with people in certain time zones. The geographic priority indicators may also display which time zone is prioritized for the indicated block of time. For example, the first geographic priority indicator 408 states that the time block of 8-10 AM is best if most attendees are in IST/UTC+5:30. The second geographic priority indicator 410 states that the time block of 10 AM-12 PM is best if most attendees are in EST/UTC-08:00. The third geographic priority indicator 412 states that the block of time from 3-5 PM is best if most attendees are in AEST/UTC+10:00.

The calendar preview interface 402 may also provide a best-time recommendation 404 for a time for the meeting. The best-time recommendation 404 is based on the cross-geographic preferences of the set attendee(s) (Fred Doe in this example) and the time zone of the meeting organizer (e.g., the user scheduling the meeting).

FIG. 5 depicts an example meeting creation user interface 500. The meeting creation user interface 500 may be presented to the user when the user is attempting to schedule a meeting. The meeting creation user interface 500 includes a meeting title input element 502, an attendee input element 504, a repeating meeting option 512, a location input element 514, a virtual meeting selection option 516, and a message body 518. The title for the meeting may be edited via the meeting title input element 502. Attendees for the meeting may be added or removed via the attendee input element 504. In the example depicted, a first attendee (Akiko Fumiko) and second attendee (Helga Svenson) have been added to the meeting, as represented by a first attendee indicator 508 and a second attendee indicator 510.

When the attendee(s) are added to the meeting, the conferencing application (or other corresponding application) retrieves the calendaring signals for the added attendees. The calendaring signals may include the calendar availability for the attendee(s) as well as the location attributes (e.g., time zone signal) and the cross-geographic preference signal(s) for the attendee(s). If one or more of the attendees have selected the send-message option 330 or set a reminder message, that message or signal is also retrieved by the conferencing application. A comparison is then made between the working hours of the attendee(s) in the time zone of the attendee(s) and the current proposed time for the meeting. If the proposed time for the meeting is outside of the working hours of the attendee(s) in their time zone, a time zone reminder message 506 is displayed in the meeting creation user interface 500. The time zone reminder message 506 indicates that the proposed time for the meeting is outside the working hours of one or more of the attendees' working hours in their local time zone. The time zone reminder message 506 may indicate which of the attendees is affected by the proposed time of the meeting being outside working hours. In some examples, an alternative time may also be automatically generated and displayed in the time zone reminder message 506. By displaying the time zone reminder message 506, the meeting organizer is less likely to schedule a meeting that will need to be rescheduled due to one or more of the attendees not being able to attend. As such, computing resources associated with rescheduling the meeting and/or holding multiple meetings are conserved.

Additionally or alternatively, the reminder message may indicate that a proposed time for the meeting is in a time that is reserved or prioritized for working with specific time zones, such as the geographic priority indicators or blocks discussed above. Accordingly, a meeting organizer may be able to determine whether the meeting is appropriate for a particular time based on the time zones of the attendees of the meeting.

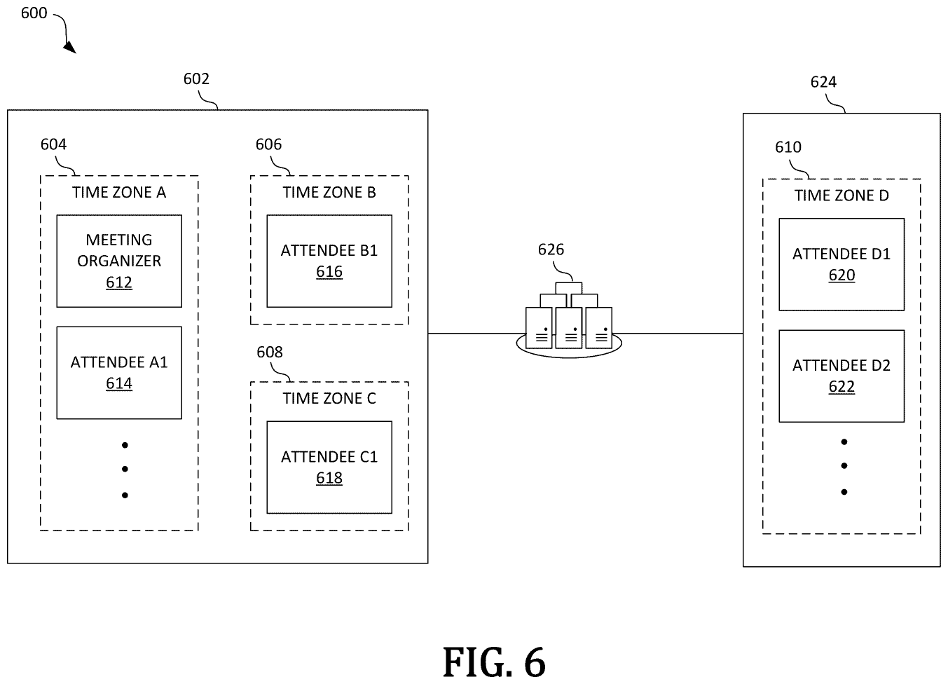

FIG. 6 depicts an example system 600 of computing devices in different time zones. The example system 600 includes a plurality of different users and computing devices within a first organization or enterprise network 602 or federated set of computing devices and another plurality of different users and computing devices within a second organization or enterprise network 624 or federated set of computing devices. In the example system, six different computing devices associated with six different users are represented. The six computing devices are distributed across four different time zones. For instance, a meeting organizer computing device 612 and an Attendee A1 computing device 614 are locating in first time zone (Time Zone A). The meeting organizer device 612 and the Attendee A1 computing device 614 may be located in the same geographic location and may be part of a first local area network 604. An Attendee B1 computing device 614 is located in a second time zone (Time Zone B) and in a second local area network 606. An Attendee C1 computing device 618 is located in a third time zone (Time Zone C) and in a third local area network 608.

An Attendee D1 computing device 620 and an Attendee D2 computing device 622 are located in a fourth time zone and may be in a fourth local area network 610. The attendee D1 computing device 620 and the Attendee D2 computing device 622 are within a second organization or enterprise 624. The computing devices within the first enterprise 602 may be in communication with one another on a first wide area network, and the computing devices within the second enterprise 624 may communicate with one another via a second wide area network. The computing devices may also communicate with a server 626 or set of servers that provide cloud-based services.

The users of the computing devices within the first enterprise 602 may choose or select to share additional details about their cross-geographic preferences and/or time zone signals with other users within the organization. Those same users may also limit the detail level that are shared with users in the second enterprise 624. These privacy preferences may be stored or otherwise utilized by the server 626 when transmitting or otherwise processing the cross-geographic preferences and/or time zone signals.

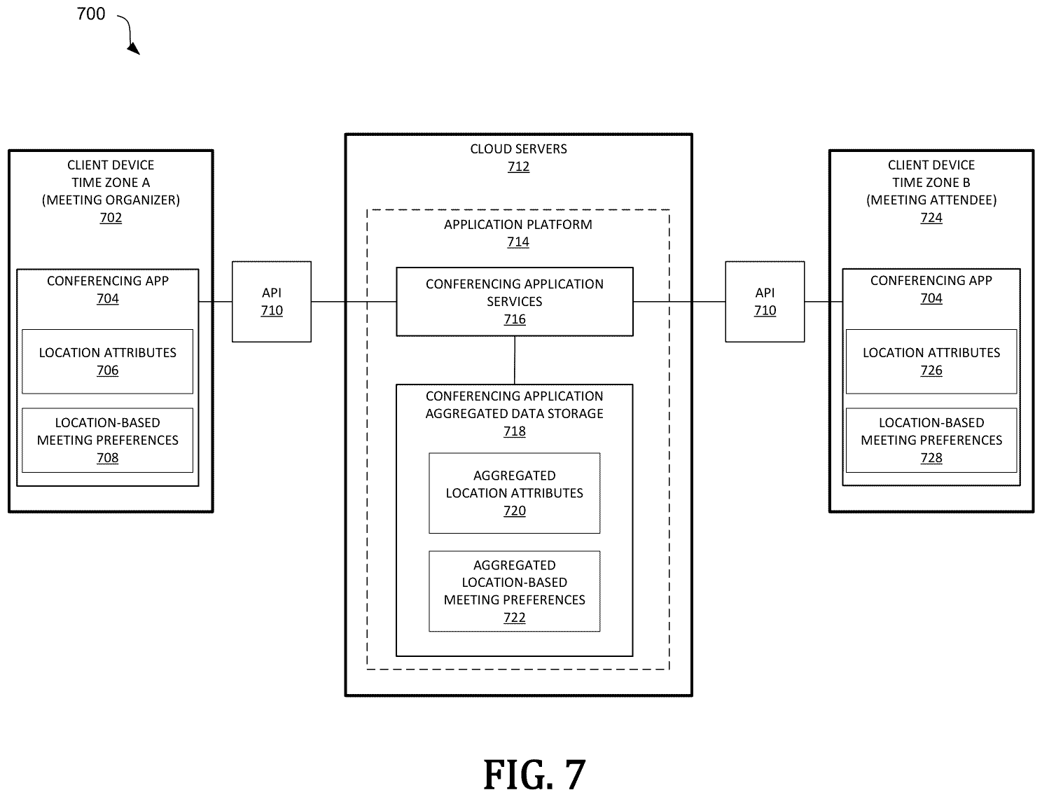

FIG. 7 depicts an example system 700 for facilitating cross-geographic scheduling. In the example depicted, a meeting organizer located in Time Zone A uses a meeting organizer client device 702 to schedule a meeting with a single attendee located in Time Zone B, who is using an attendee client device 724. The meeting organizer and attendee both use a common conferencing application 704, though the meeting may be scheduled using any functionally similar and compatible feature or app, such as a virtual calendar or other scheduling feature. The conferencing application 704 is any type of application that allows for a scheduling of virtual meetings through a virtual calendar (e.g., email applications, calendaring applications, collaboration applications, etc.). The conferencing application 704 may require a user login or similar identity verification, so that an individual may login and use the conferencing application 704 on any device on which the conferencing application 704 is configured to operate. As such, the client devices 702 and 724 may be any of a desktop or laptop computer, a mobile device, such as a mobile phone or tablet, or any similar device on which the conferencing application 704 is capable of operating. Furthermore, the meeting organizer and attendee may, at different times, operate the conferencing application 704 on different client devices 702 or 724, respectively. As an example, the meeting organizer may schedule the meeting using a laptop computer, modify the meeting using a tablet, and attend the meeting on a mobile phone. The meeting attendee may have the same flexibility in working with the scheduling of the virtual meeting and attending the virtual meeting.

As described in the preceding figures and corresponding discussion, a user of the conferencing application 704 may choose to specify location-based meeting preferences 708 or 728, and share these preferences and other location attributes 706 or 726 with other users of the conferencing application 704. Location attributes 706 or 726 may include a user's time zone, stretch time configurations, local or regional holidays, observances that are particular to that time zone, and/or other geographically pertinent information. Likewise, as previously described, location-based meeting preferences 708 or 728 may include time periods reserved for meetings with specific cross-geographic collaborators, automatic indications of best meeting times for meeting organizers in other time zones, and/or pre-written reminder messages to meeting organizers about time-zone-dependent scheduling restrictions. For instance, the location attributes may be user-specific and may include the cross-geographic preferences and/or the time zone details described above.

The conferencing application 704 operating on a client device 702 or 724 may interface with a cloud-based application platform 714 that coordinates scheduling and related features through conferencing application services 716. The application platform 714 may be a software subscription service operating on cloud servers 712, where a family of software products and related services are accessed via the internet, by subscribers in differing geographic locations. An example of an application platform is Microsoft 365° services, which offer conferencing, virtual calendar, and related scheduling services, among other services. The conferencing application services 716 may be one of the services bundled within an application platform 714, though in other examples the conferencing application services 716 may not be affiliated with a specific application platform 714.

The conferencing application services 716 may coordinate and facilitate meeting scheduling by relaying meeting-related information between the meeting organizer client device 702 and the attendee client device 724. Such information includes, but is not limited to, attendee availability, attendee time zone signals (such as attendee location attributes 726 and location-based meeting preferences 728), conference room availability, attendee meeting acceptance decisions, requests for alternate meeting times, and other related information. The application platform 714 may also provide, or have access to, cloud-based conferencing application aggregated data storage 718, where the above information may be stored, and later accessed by cross-geographic users. The conferencing application aggregated data storage 718 may include dedicated cloud-based storage for aggregated location attributes 720 and aggregated location-based meeting preferences 722, which contain the attributes and preferences of users who have elected to specify and share this information. For example, a meeting attendee in Time Zone B may power-off the attendee client device 724 during non-waking hours. A meeting organizer in Time Zone A may still wish to schedule a meeting with the attendee in Time Zone B, and therefore needs to access information related to the attendee's availability. The location attributes 726 and location-based meeting preferences 728 for that attendee are still available to the meeting organizer client device 702, through the stored aggregated location attributes 720 and aggregated location-based meeting preferences 722.

The client devices 702 and 724 may interface with the conferencing application services 716 via an application programming interface (API) 710. An API 710 is an interface in which one application follows the communication standards or protocols of the interface to communicate with another application. The example depicted in FIG. 7 uses on an API 710 to interface the conferencing application 704 to the cloud-based conferencing application services 716. However, in other examples, a conferencing application 704, or related feature, may not require the use of an API 710. The use of the API 710 may also allow for different applications to interact and access the conferencing application aggregated data storage 718 as well as allow for additional data to be stored or deposited within the conferencing application aggregated data storage 718.

The system depicted in FIG. 7 is an example illustration of how a conferencing application 704 and cloud-based conferencing application services 716 interconnect two client devices 702 and 724 for scheduling a virtual meeting. It should be noted, however, that this framework is expandable and is capable of supporting significantly larger numbers of attendees. These attendees may be located in a multitude of disparate time zones, with some working in a home-based office environment, or others working from the premises of a business. The conferencing application services 716 and conferencing application aggregated data storage 718 provide the framework for sharing, storing, and accessing the time zone signals of prospective attendees.

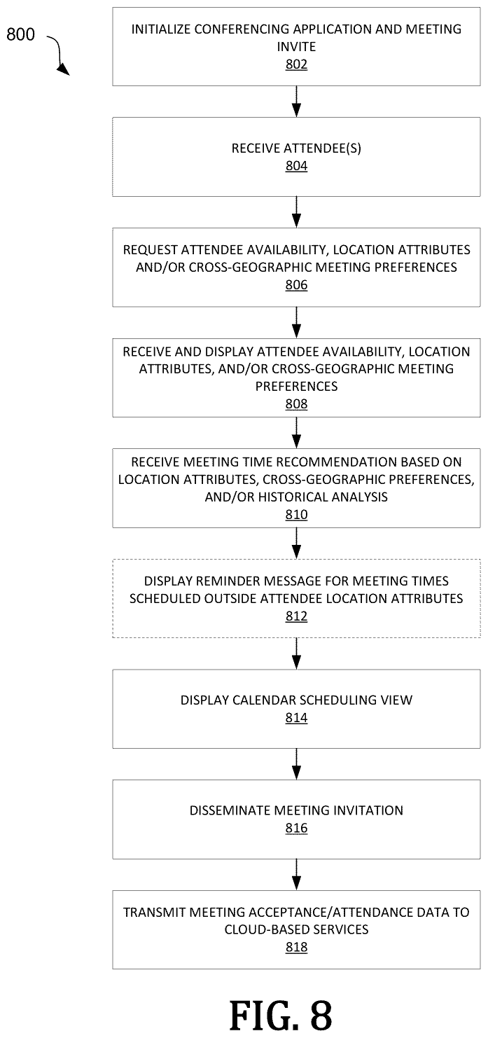

FIG. 8 depicts an example method 800 for cross-geographic scheduling. The example method 800 may be performed by a client application operating on a client device and/or a web-based application operating on a server and causing the display of application features through a web browser. At operation 802, a conferencing application is initialized. The conferencing application may be any application that can facilitate the scheduling of a meeting, such as an e-mail application, calendar application, meeting application, collaboration or other similar application. Initializing the application may be in response to a user selecting the application. Operation 802 may also include generating an invitation for a virtual meeting. The invitation may be generated in response to user interaction with one or more user interface features of the conferencing application.

At operation 804, one or more attendees are received by the conferencing application into the meeting invitation. The attendees may be added manually by the user into the attendee or invitee field of the meeting invitation. At operation 806, attendee availability, location attributes, and/or cross-geographic meeting preferences are requested for the attendees(s) added in operation 804. The request may be in the form of a request for scheduling data of the attendee(s). For example, when an attendee is added to the meeting invitation, an identifier or ID for that user is queried or otherwise accessed. The identifier for the attendee may then be used to query or request additional data about the user from a remote storage location, such as the conferencing application aggregated data storage, which stores data for multiple users of the conferencing application or corresponding platform. The query request may include the identifier(s) of the attendee(s) as well as the data that is to be returned. In some examples, the specific types of data to be returned may be explicitly specified. In other examples, the query may indicate that the request is for a virtual meeting invite, and the storage platform returns the data associated with a meeting invite, such as attendee availability, location attributes, and/or cross-geographic meeting preferences. The storage platform processes this query and returns the requested data to the client device. At operation 808, the requested data is received from the storage platform.

At operation 810, a meeting time recommendation is received. In some examples, generation of the meeting time recommendation is performed at the server or cloud-based service, but in other examples generation of the meeting time recommendation is performed locally by the client device. The meeting time recommendation is generated based on the attendee availability, location attributes, and/or cross-geographic meeting preferences for the attendee(s) that have been added to the meeting invite. For instance, decision heuristics may be applied to the data to generate a meeting time recommendation. As an example, the logic may first remove times where one or more attendees have a conflicting meeting already scheduled. The logic may then look for open time that is within the working hours of each attendee in their local time zones. If a time slot is available within the working hours for all attendees, the cross-geographic preferences of the attendee(s) are analyzed as well as the location attributes for the attendees. For example, the time zone of the majority of the attendees is analyzed, and the recommended meeting time is within the priority block according to the cross-geographic preferences of one or more the attendees.

If no open time is available within the working hours, the stretch time is analyzed to determine if a meeting time of the set duration is available in stretch time of all the attendees. If there is a meeting time available within the stretch time, the recommended time is the time frame that is closest to the working hours of the attendee(s) for which the meeting would be in their respective stretch time. For example, if the only time available for a 30 minute meeting is within stretch time of 8-9 AM, the recommended meeting time will be 8:30-9:00 AM rather than 8-8:30 AM because the later time slot is closer to the working hours of the respective attendee. If no time slot is available in stretch time or working hours for all attendees, non-working hours may be analyzed to find an open time slot that is closest to the stretch time or working time for the attendee(s) where the meeting would be outside of working hours. In such cases, a notification may also be displayed with the recommended meeting time that indicates the recommended meeting time is outside of working hours for one or more attendees, and the names of the attendees may also be displayed.

Additionally or alternatively, the meeting time recommendation may be generated from a machine learning model, such as a neural network. For instance, the machine learning model may receive as input the attendee availability, location attributes, and cross-geographic meeting preferences of the attendee(s) and the meeting organizer. The machine learning model has been previously trained on the same types of inputs as well as previously determined acceptable or optimal meeting times for the respective inputs. In such examples, supervised training of the machine learning model may be accomplished with the input data set being the prior attendee availability, location attributes, and cross-geographic meeting preferences and the output being the successful meeting time.

The machine learning model may also be continuously trained or reinforced through the use of monitored scheduling data. For instance, meeting attendance data as well as the respective attendee availability, location attributes, and cross-geographic meeting preferences of the attendee(s) and the meeting organizer may be tracked/monitored and used as additional training data for the machine learning model. For example, if a meeting is scheduled, and later canceled, that data point may be associated as a negative or unsuccessful time for the meeting. Similarly, if the meeting is scheduled, and multiple attendees do not attend the meeting, that data point may also be associated as a negative or unsuccessful time for the meeting. The machine learning model may then be updated such that corresponding times based on the inputs are given a lower weight and less likely to be recommended. Conversely, if a meeting is scheduled and fully attended, that data point may be associated as a positive or successful time for the meeting. The machine learning model may then be updated such that corresponding times based on the inputs are given a higher weight and more likely to be recommended. Such data may also be used to adjust or update heuristics or other logic used for generating the meeting time recommendation. Accordingly, the recommended meeting time may be further based on a historical analysis of prior meetings and their attendance rate and/or rate of rescheduling.

At operation 812, if the set time for the meeting is outside of working hours for one or more the attendees based on the received attendee location attributes, a reminder message may be displayed that indicates the set meeting time is outside of working hours for the corresponding attendees. Such a reminder message may be similar to the message shown in FIG. 5, and the content of the message may be received in operation 808 as part of the location attributes for the attendees. At operation 814, a calendar scheduling view is displayed based on at least one of the attendee availability, location attributes, and cross-geographic preferences. Such calendar views may include data or representations as set forth in the figures, such as FIGS. 1-2, and discussed above.

Once a time is set for the meeting by the user, the meeting invitation is disseminated or sent to the attendees at operation 816. At operation 818, meeting acceptances and/or attendance data may be sent to the remote or cloud-based services platform, and that meeting acceptance and/or attendance data may be used to refine, reinforce, and/or train the heuristics or machine learning models used to generate the recommended meeting time. In some examples, the meeting acceptances and/or attendance data may be received by the remote or cloud-based services platform concurrently or before such data is received by the client device. In such examples, the data need not be sent to the services platform by the client device.

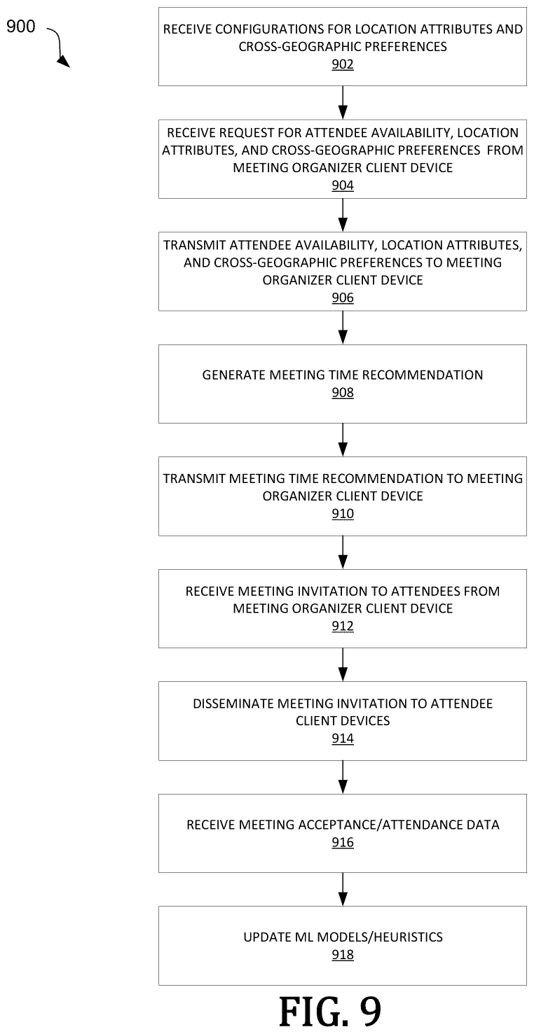

FIG. 9 depicts an example method 900 for cross-geographic scheduling. The method 900 may be performed by a server or cloud-based service. At operation 902, configurations for location attributes and/or cross-geographic preferences for a plurality of users are received. The configuration may be received based on input into a user interface, such as the user interface depicted in FIG. 3. For instance, the location attributes may include a current location and/or future location details for one or more users. The location attributes may further include a reminder message content for display when meetings are attempted to be scheduled outside of the working hours of the user. The cross-geographic preferences may include one or more locations with which the user frequently works. The configurations are then stored in an aggregate storage (e.g., database) that can be accessed or queried from a plurality of client devices.

At operation 904, a request for attendee availability, location attributes, and cross-geographic preferences is received from a meeting organizer client device. The request may be received as a query for the respective data along with attendee identifiers, as discussed above. In response to receiving the request at operation 904, a query is executed against the aggregate storage for which the configurations were stored in operation 902. The results of the query (e.g., the attendee availability, location attributes, and cross-geographic preferences) may then be transmitted to the meeting organizer client device in operation 906.

At operation 908, a meeting time recommendation is generated. The meeting time recommendation may be generated using the heuristics, logic, and/or machine learning model(s) discussed above. At operation 910, the meeting time recommendation that was generated in operation 908 is transmitted to the meeting organizer client device. At operation 912, a meeting invitation specifying the attendees and time for meeting, among other potential configurations such as those shown in FIG. 5, may be received from the meeting organizer client device. The cloud-service may then disseminate or transmit the received meeting invitation to the listed attendees at operation 914.

At operation 916, meeting acceptance and/or attendance data is received for the meeting. That meeting acceptance and/or attendance data is then correlated with the attendee availability data, location attributes, and/or cross-geographic preferences that were accessed for the meeting in operations 904-906. At operation 918, the meeting acceptance and/or attendance data may then be used to update, train, and/or reinforce the machine learning models and/or heuristics used to generate the recommended meeting time, as discussed above.

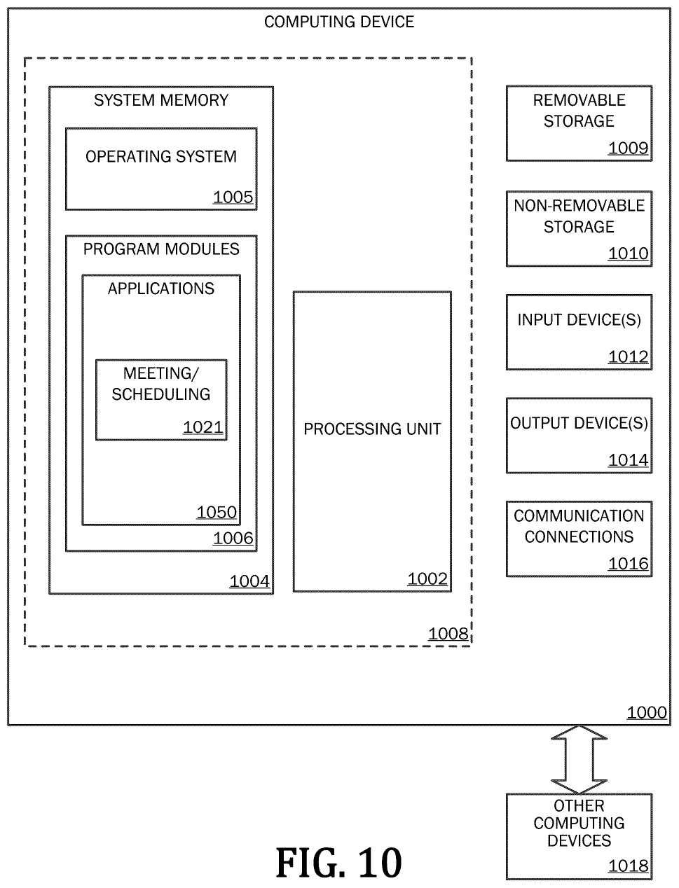

FIG. 10 is a block diagram illustrating physical components (i.e., hardware) of a computing device 1000 with which examples of the present disclosure may be practiced. The computing device components described below may be suitable for a client device running the web browser discussed above. In a basic configuration, the computing device 1000 may include at least one processing unit 1002 and a system memory 1004. The processing unit(s) (e.g., processors) may be referred to as a processing system. Depending on the configuration and type of computing device, the system memory 1004 may comprise, but is not limited to, volatile storage (e.g., random access memory), non-volatile storage (e.g., read-only memory), flash memory, or any combination of such memories. The system memory 1004 may include an operating system 1005 and one or more program modules 1006 suitable for running software applications 1050 such as a meeting or scheduling application 1021.

The operating system 1005, for example, may be suitable for controlling the operation of the computing device 1000. Furthermore, aspects of the invention may be practiced in conjunction with a graphics library, other operating systems, or any other application program and is not limited to any particular application or system. This basic configuration is illustrated in FIG. 10 by those components within a dashed line 1008. The computing device 1000 may have additional features or functionality. For example, the computing device 1000 may also include additional data storage devices (removable and/or non-removable) such as, for example, magnetic disks, optical disks, or tape. Such additional storage is illustrated in FIG. 10 by a removable storage device 1009 and a non-removable storage device 1010.

As stated above, a number of program modules and data files may be stored in the system memory 1004. While executing on the processing unit 1002, the program modules 1006 may perform processes including, but not limited to, one or more of the operations of the methods illustrated in FIGS. 8-9. Other program modules that may be used in accordance with examples of the present invention and may include applications such as electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the computing device 1000 on the single integrated circuit (chip). Examples of the present disclosure may also be practiced using other technologies capable of performing logical operations such as, for example, AND, OR, and NOT, including but not limited to mechanical, optical, fluidic, and quantum technologies.

The computing device 1000 may also have one or more input device(s) 1012 such as a keyboard, a mouse, a pen, a sound input device, a touch input device, etc. The output device(s) 1014 such as a display, speakers, a printer, etc. may also be included. The aforementioned devices are examples and others may be used. The computing device 1000 may include one or more communication connections 1016 allowing communications with other computing devices 1018. Examples of suitable communication connections 1016 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1004, the removable storage device 1009, and the non-removable storage device 1010 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1000. Any such computer storage media may be part of the computing device 1000. Computer storage media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

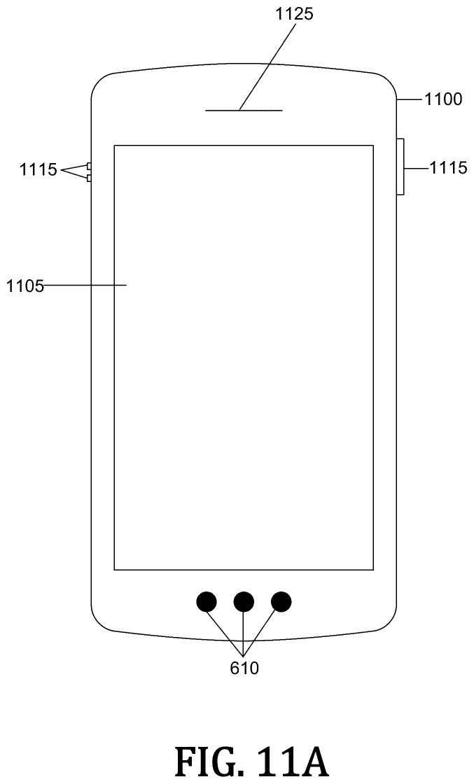

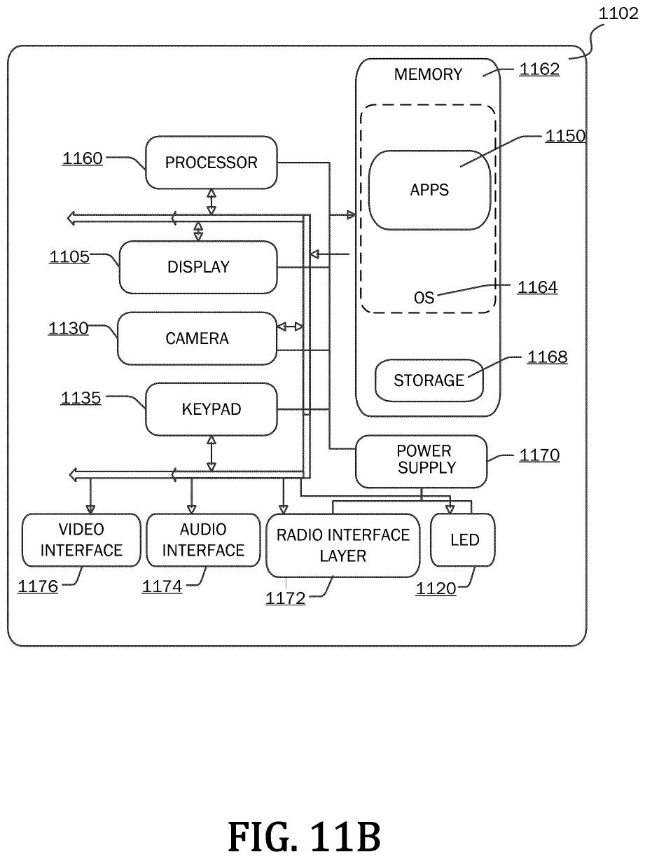

FIGS. 11A and 11B illustrate a mobile computing device 1100, for example, a mobile telephone, a smart phone, a tablet personal computer, a laptop computer, and the like, with which aspects of the invention may be practiced. With reference to FIG. 11A, an example of a mobile computing device 1100 for implementing at least some aspects of the present technology is illustrated. In a basic configuration, the mobile computing device 1100 is a handheld computer having both input elements and output elements. The mobile computing device 1100 typically includes a display 1105 and one or more input buttons 1110 that allow the user to enter information into the mobile computing device 1100. The display 1105 of the mobile computing device 1100 may also function as an input device (e.g., a touch screen display). If included, optional side input elements 1115 allows further user input. The side input elements 1115 may include buttons, switches, or any other type of manual input elements. In alternative examples, mobile computing device 1100 may incorporate more or less input elements. Key input may generally be received from a soft keyboard displayed on the display 1105, but in other examples, the mobile computing device 1100 may also include an optional physical keypad. Optional keypad 1135 may be a physical keypad or a “soft” keypad generated on the touch screen display. One or more audio transducers 1125 (e.g., speakers) may also be included. In some examples, the mobile computing device 1100 incorporates a vibration transducer for providing the user with tactile feedback. In yet another example, the mobile computing device 1100 incorporates input and/or output ports, such as an audio input (e.g., a microphone jack), an audio output (e.g., a headphone jack), and/or a video output for sending signals to or receiving signals from an external device.

FIG. 11B is a block diagram illustrating the architecture of one example of a mobile computing device. That is, the mobile computing device 1100 can incorporate a system (i.e., an architecture) 1102 to implement some examples. In one example, the system 1102 is implemented as a “smart phone” capable of running one or more applications (e.g., videoconference or virtual meeting application, web browser, e-mail, calendaring, contact managers, messaging clients, games, and media clients/players). In some examples, the system 1102 is integrated as a computing device, such as an integrated personal digital assistant (PDA) or wireless phone.

One or more application programs 1150 may be loaded into the memory 1162 and run on or in association with the operating system 1164. Examples of the application programs include videoconference or virtual meeting programs, phone dialer programs, e-mail programs, personal information management (PIM) programs, word processing programs, spreadsheet programs, Internet browser programs, messaging programs, and so forth. The system 1102 also includes a non-volatile storage area 1168 within the memory 1162. The non-volatile storage area 1168 may be used to store persistent information that should not be lost if the system 1102 is powered down. The application programs 1150 may use and store information in the non-volatile storage area 1168, such as e-mail or other messages used by an e-mail application, and the like. A synchronization application (not shown) may also reside on the system 1102 and is programmed to interact with a corresponding synchronization application resident on a host computer to keep the information stored in the non-volatile storage area 1168 synchronized with corresponding information stored at a remote device or server. As should be appreciated, other applications may be loaded into the memory 1162 and run on the mobile computing device 1100.

The system 1102 has a power supply 1170, which may be implemented as one or more batteries. The power supply 1170 might further include an external power source, such as an AC adapter or a powered docking cradle that supplements or recharges the batteries.

The system 1102 may also include a radio 1172 that performs the function of transmitting and receiving radio frequency communications. The radio 1172 facilitates wireless connectivity between the system 1102 and the “outside world,” via a communications carrier or service provider. Transmissions to and from the radio 1172 are conducted under control of the operating system 1164. In other words, communications received by the radio 1172 may be disseminated to the application programs 1150 via the operating system 1164, and vice versa.

The visual indicator 1120 may be used to provide visual notifications and/or an audio interface 1174 may be used for producing audible notifications via the audio transducer 1125. In the illustrated example, the visual indicator 1120 is a light emitting diode (LED) and the audio transducer 1125 is a speaker. These devices may be directly coupled to the power supply 1170 so that when activated, they remain on for a duration dictated by the notification mechanism even though the processor 1160 and other components might shut down for conserving battery power. The LED may be programmed to remain on indefinitely until the user takes action to indicate the powered-on status of the device. The audio interface 1174 is used to provide audible signals to and receive audible signals from the user. For example, in addition to being coupled to the audio transducer 1125, the audio interface 1174 may also be coupled to a microphone to receive audible input, such as to facilitate a telephone conversation. The system 1102 may further include a video interface 1176 that enables an operation of an on-board camera 1130 to record still images, video stream, and the like.

A mobile computing device 1100 implementing the system 1102 may have additional features or functionality. For example, the mobile computing device 1100 may also include additional data storage devices (removable and/or non-removable) such as, magnetic disks, optical disks, or tape. Such additional storage is illustrated in FIG. 11B by the non-volatile storage area 1168.

Data/information generated or captured by the mobile computing device 1100 and stored via the system 1102 may be stored locally on the mobile computing device 1100, as described above, or the data may be stored on any number of storage media that may be accessed by the device via the radio 1172 or via a wired connection between the mobile computing device 1100 and a separate computing device associated with the mobile computing device 1100, for example, a server computer in a distributed computing network, such as the Internet. As should be appreciated such data/information may be accessed via the mobile computing device 1100 via the radio 1172 or via a distributed computing network. Similarly, such data/information may be readily transferred between computing devices for storage and use according to data/information transfer and storage means, including electronic mail and collaborative data/information sharing systems.

As will be understood from the foregoing disclosure, many technical advantages and improvements result from the present technology. For instance, the present technology provides for significant improvement in computing resources associated with having to reschedule virtual meetings or host multiple virtual meetings due to dispersed global locations of the attendees. In an aspect, the technology relates to a system for scheduling a virtual meeting. The system includes at least one processor; and memory storing instructions that, when executed by the at least one processor cause the system to perform operations. The operations include receiving configurations for location attributes and cross-geographic preferences for a plurality of users; storing the received configurations in a data storage; receiving, from a meeting organizer client device, a request scheduling data for one or more attendees of a virtual meeting; accessing, from the data storage, location attributes and cross-geographic preferences for the one or more attendees; generating, based on at least the accessed location attributes and cross-geographic preferences, a meeting time recommendation; and transmitting the accessed location attributes, cross-geographic preferences, and the generated meeting time recommendation to the meeting organizer client device.

In an example, generating the meeting time recommendation includes applying heuristics against the location attributes and the cross-geographic preferences. In another example, generating the meeting time recommendation includes providing the location attributes and the cross-geographic preferences to a trained machine learning model. In a further example, the operations further include tracking at least one of meeting acceptance data or meeting attendance data; and reinforcing the trained machine learning model based on the at least one of the meeting acceptance data or the meeting attendance data. In yet another example, the location attributes include a time zone, a stretch time duration, and a working hours duration. In still another example, the location attributes include a current time zone and a future time zone for a user. In still yet another example, the location attributes include a reminder message to be displayed for a user when a meeting is attempted to be scheduled outside of working hours of the user in the user's local time zone. In another example, the cross-geographic preferences includes an indication of a location with which a user frequently works.

In another aspect, the technology relates to a method for scheduling a virtual meeting. The method includes receiving configurations for location attributes and cross-geographic preferences for a plurality of users; storing the received configurations in a data storage; receiving, from a meeting organizer client device, a request for location attributes and cross-geographic preferences for one or more attendees of a virtual meeting; accessing, from the data storage, the requested location attributes and cross-geographic preferences for the one or more attendees; generating, based on at least the requested location attributes and cross-geographic preferences, a meeting time recommendation; and transmitting the accessed location attributes, cross-geographic preferences, and the generated meeting time recommendation to the meeting organizer client device.

In an example, generating the meeting time recommendation includes applying heuristics against the location attributes and the cross-geographic preferences. In another example, generating the meeting time recommendation includes providing the location attributes and the cross-geographic preferences to a trained machine learning model. In a further example, the method further includes tracking at least one of meeting acceptance data or meeting attendance data; and reinforcing the trained machine learning model based on the at least one of the meeting acceptance data or the meeting attendance data. In yet another example, the method further includes receiving a configuration to one or more location attributes of the one or more attendees, and storing the configuration in the data storage. In still another example, the location attributes include a future time zone for a user. In still yet another example, the cross-geographic preferences includes an indication of a location with which a user frequently works.

In another example, the technology relates to a system for scheduling a virtual meeting. The system includes at least one processor; and memory storing instructions that, when executed by the at least one processor cause the system to perform operations. The operations include receiving, as input into a meeting scheduling interface, one or more attendees for a virtual meeting; sending a request, to a remote service, for location attributes of the one or more attendees; receiving, from the remote service, the requested location attributes; and causing display of a scheduling user interface the virtual meeting. The scheduling user interface includes a first attendee indicator; a second attendee indicator; a first attendee time zone indicator adjacent to the first attendee indicator to indicate a time zone of the first attendee, the first attendee time zone indicator being based on the received location attributes; a second attendee time zone indicator adjacent to the second attendee indicator to indicate a time zone of the second attendee, the second attendee time zone indicator being based on the received location attributes; and a calendar grid, the calendar grid including a first row indicating availability of the first attendee and a second row indicating availability of the second attendee.

In an example, the first row includes a first indicator for non-working hours of the first attendee, a second indicator for stretch time of the first attendee, and a third indicator for working hours of the first attendee. In another example, the second attendee time zone indicator indicates a local time for the second attendee corresponding to a selected time for the virtual meeting. In still another example, the operations further include receiving, from the remote service, cross-geographic preferences for the one or more attendees. In yet another example, the operations further include causing display of one or more geographic priority indicators based on the received cross-geographic preferences for the one or more attendees.

Those skilled in the art will recognize that the methods and systems of the present disclosure may be implemented in many manners and as such are not to be limited by the foregoing aspects and examples. In other words, functional elements being performed by a single or multiple components. In this regard, any number of the features of the different aspects described herein may be combined into single or multiple aspects, and alternate aspects having fewer than or more than all of the features herein described are possible. Functionality may also be, in whole or in part, distributed among multiple components, in manners now known or to become known.

Further, as used herein and in the claims, the phrase “at least one of element A, element B, or element C” is intended to convey any of: element A, element B, element C, elements A and B, elements A and C, elements B and C, and elements A, B, and C. In addition, one having skill in the art will understand the degree to which terms such as “about” or “substantially” convey in light of the measurement techniques utilized herein. To the extent such terms may not be clearly defined or understood by one having skill in the art, the term “about” shall mean plus or minus ten percent.

Numerous other changes may be made which will readily suggest themselves to those skilled in the art and which are encompassed in the spirit of the disclosure and as defined in the appended claims. While various aspects have been described for purposes of this disclosure, various changes and modifications may be made which are well within the scope of the disclosure. Numerous other changes may be made which will readily suggest themselves to those skilled in the art and which are encompassed in the spirit of the disclosure and as defined in the claims.

What is claimed is:

1. A system for scheduling a virtual meeting, the system comprising:
at least one processor; and
memory storing instructions that, when executed by the at least one processor cause the system to perform operations comprising:
receiving configurations for location attributes and cross-geographic preferences for a plurality of users;
storing the received configurations in a data storage;
receiving, from a meeting organizer client device, a request scheduling data for one or more attendees of a virtual meeting;
accessing, from the data storage, location attributes and cross-geographic preferences for the one or more attendees;
generating, based on at least the accessed location attributes and cross-geographic preferences, a meeting time recommendation; and
transmitting the accessed location attributes, cross-geographic preferences, and the generated meeting time recommendation to the meeting organizer client device.

2. The system of claim 1, wherein generating the meeting time recommendation includes applying heuristics against the location attributes and the cross-geographic preferences.

3. The system of claim 1, wherein generating the meeting time recommendation includes providing the location attributes and the cross-geographic preferences to a trained machine learning model.

4. The system of claim 3, wherein the operations further comprise:
tracking at least one of meeting acceptance data or meeting attendance data; and
reinforcing the trained machine learning model based on the at least one of the meeting acceptance data or the meeting attendance data.

5. The system of claim 1, wherein the location attributes include a time zone, a stretch time duration, and a working hours duration.

6. The system of claim 1, wherein the location attributes include a current time zone and a future time zone for a user.

7. The system of claim 1, wherein the location attributes include a reminder message to be displayed for a user when a meeting is attempted to be scheduled outside of working hours of the user in the user's local time zone.

8. The system of claim 1, the cross-geographic preferences includes an indication of a location with which a user frequently works.

9. A method for scheduling a virtual meeting, the method comprising:
receiving configurations for location attributes and cross-geographic preferences for a plurality of users;
storing the received configurations in a data storage;
receiving, from a meeting organizer client device, a request for location attributes and cross-geographic preferences for one or more attendees of a virtual meeting;
accessing, from the data storage, the requested location attributes and cross-geographic preferences for the one or more attendees;
generating, based on at least the requested location attributes and cross-geographic preferences, a meeting time recommendation; and
transmitting the accessed location attributes, cross-geographic preferences, and the generated meeting time recommendation to the meeting organizer client device.

10. The method of claim 9, wherein generating the meeting time recommendation includes applying heuristics against the location attributes and the cross-geographic preferences.

11. The method of claim 9, wherein generating the meeting time recommendation includes providing the location attributes and the cross-geographic preferences to a trained machine learning model.

12. The method of claim 11, further comprising:
tracking at least one of meeting acceptance data or meeting attendance data; and
reinforcing the trained machine learning model based on the at least one of the meeting acceptance data or the meeting attendance data.

13. The method of claim 10, further comprising receiving a configuration to one or more location attributes of the one or more attendees, and storing the configuration in the data storage.

14. The method of claim 10, wherein the location attributes include a future time zone for a user.

15. The method of claim 10, wherein the cross-geographic preferences includes an indication of a location with which a user frequently works.

16. A system for scheduling a virtual meeting, the system comprising:
at least one processor; and
memory storing instructions that, when executed by the at least one processor cause the system to perform operations comprising:
receiving, as input into a meeting scheduling interface, one or more attendees for a virtual meeting;
sending a request, to a remote service, for location attributes of the one or more attendees;
receiving, from the remote service, the requested location attributes; and
causing display of a scheduling user interface the virtual meeting, the scheduling user interface comprising:
a first attendee indicator;
a second attendee indicator;
a first attendee time zone indicator adjacent to the first attendee indicator to indicate a time zone of the first attendee, the first attendee time zone indicator being based on the received location attributes;
a second attendee time zone indicator adjacent to the second attendee indicator to indicate a time zone of the second attendee, the second attendee time zone indicator being based on the received location attributes; and
a calendar grid, the calendar grid including a first row indicating availability of the first attendee and a second row indicating availability of the second attendee.

17. The system of claim 16, wherein the first row includes a first indicator for non-working hours of the first attendee, a second indicator for stretch time of the first attendee, and a third indicator for working hours of the first attendee.

18. The system of claim 16, wherein the second attendee time zone indicator indicates a local time for the second attendee corresponding to a selected time for the virtual meeting.

19. The system of claim 16, wherein the operations further comprise receiving, from the remote service, cross-geographic preferences for the one or more attendees.

20. The system of claim 19, wherein the operations further comprise causing a display of one or more geographic priority indicators based on the received cross-geographic preferences for the one or more attendees.
